(19) United States
(12) Patent Application Publication
(10) Pub. No.: US 2015/0169833 A1
(43) Pub. Date: Jun. 18, 2015

(54) Method and System for Supporting a Clinical Diagnosis

(71) Applicants: Ulli Waltinger, Munchen (DE); Sonja Zillner, Munchen (DE)

(72) Inventors: Ulli Waltinger, Munchen (DE); Sonja Zillner, Munchen (DE)

(21) Appl. No.: 14/162,670

(22) Filed: Jan. 23, 2014

(30) Foreign Application Priority Data
Dec. 16, 2013 (EP) 13197463

(51) Int. Cl. G06F 19/00

(52) U.S. Cl. CPC G06F 19/34

(57) ABSTRACT

Medical experts are supported in the process of specifying and fine-tuning initial search requests by aggregating additional information about a patient context (e.g., patient, assumption, internal diagnose, external diagnose and procedure context). Mismatching information units are subsequently used as an entry point for improved and tailored information access by question answering systems. Different to traditional similarity-driven evidence ranking, an approach that does not disregard the mismatching information but emphasizes such silent signals is established.

### CROSS REFERENCE TO RELATED APPLICATIONS

This application claims the benefit of European Application No. 13197463.6 filed on Dec. 16, 2013.

### TECHNICAL FIELD

The present embodiments relate to a method and system for supporting a clinical diagnosis.

### BACKGROUND

Currently known systems for supporting clinical diagnosis rely on efficient knowledge access and retrieval in the clinical domain. By contrast to traditional information retrieval approaches, including query-based search engines, by which users are to wade through a large set of query-related documents, the domain of question answering allows a delivery of succinct answers to natural language questions, as posed by a user.

Question answering systems may make use of a collection of natural language documents for document retrieval, and apply selective methods in order to extract a single answer or a list of answer candidates. The applied scoring techniques for answer candidates are thereby primarily based on best matching criteria (e.g., in determining a syntactic or semantic overlap) between the interpretation of the question and the respective answer candidate.

While currently known question answering systems show a considerable performance and significantly help to improve human-computer interaction, an acceptance of question answering systems in the medical domain is still lacking. The limited acceptance may be due to drawbacks of classical systems in contrast to particular aspects of making decisions in a clinical diagnosis and treatment. For diagnosis and treatment decisions, the generic information delivered by best matching criteria is not of relevance. Relevance of information may be interpreted in the context of some assumption, such as initial suspected diagnosis. A suspected diagnoses as well as circumstances related to a patient determine the context for subsequent interpretation tasks. A question answering system is to analyze all comprehensive sets of data covering all relevant influencing factors of symptoms, findings and observations.

### SUMMARY AND DESCRIPTION

The scope of the present invention is defined solely by the appended claims and is not affected to any degree by the statements within this summary.

Due to the particular information needs of clinicians, classical approaches of question answering or information retrieval are not appropriate for clinicians in order to access relevant information units.

While scoring techniques of classical question answering systems are aiming to deliver generic information that is determined by best matching criteria between the interpretation of the question and the respective answer candidate, the information needs of clinicians are focused in a whole different direction. For diagnosis and treatment decisions, not the generic information but rather the mismatching information is of relevance. More specifically, a clinician is interested in an observation that does not fit the assumptions of a suspected diagnosis by the clinician.

Accordingly, there is a need in the art for providing a method for supporting a clinical diagnosis that enriches question answering systems by the ability of identifying mismatching information and reassessing a diagnosis in view of the mismatching information. The present embodiments may obviate one or more of the drawbacks or limitations in the related art. For example, the need described above may be met by the present embodiments.

Systems and methods in accordance with various embodiments provide for a method for supporting a clinical diagnosis.

According to an embodiment, a method for supporting a clinical diagnosis is proposed. The method includes representing a patient by a patient knowledge model including a plurality of information units and further including at least one observation. The at least one observation includes at least one information unit interrelated with at least one further information unit by at least one relationship. The method also includes determining a first set of information units within the patient knowledge model, and determining a disease assumption by querying and reasoning the first set of information units in a disease knowledge model. The method includes determining a second set of information units associated by the disease knowledge model with the disease assumption and matching the second set of information units to the first set of information units. The method also includes identifying at least one mismatching information unit included in the first set of information units, inferring, by querying and reasoning the mismatching information unit in at least one of the disease knowledge model or one of a further knowledge model. At least one suspected observation includes the mismatching information unit. The mismatching information unit is related by at least one un-typified relationship. The method also includes consolidating the at least one suspected observation into at least one typified observation by requesting at least one further information unit for interrelating the un-typified relationship. The method includes proofing the at least one un-typified relationship by querying and reasoning the un-typified relationship in at least one of the patient knowledge model or one of a further knowledge model, and integrating the at least one typified observation into the patient knowledge model and updating a weight assigned to the relationships.

The proposed embodiment establishes a way for supporting a clinical diagnosis by specifying initial assumptions in information elements and, subsequently or even by an iterative process, by inferring mismatching information units.

A patient is represented by a patient knowledge model including a plurality of information units. Information units include current and historic symptoms and findings of a patient in a structured manner. Information units further include influencing factors of the patient (e.g., interactions with drugs, considerable aspects of patient's vita or activities of the patient in the recent past). The patient knowledge model further includes at least one observation, whereby an observation includes at least one information unit interrelated with at least one further information unit by at least one relationship.

In an act of the proposed method according to an embodiment, a first set of information units within the patient knowledge model is determined in order to arrive at an initial disease assumption (i.e., suspected diagnosis). In order to determine a disease assumption, the first set of information units is queried and reasoned in a disease knowledge model covering comprehensive information about possible relationships between diseases and symptoms, whereby each disease relates to a second set of information elements of symptoms associated to a specific disease. The second set of information units is matched to the first set of information units in order to identify at least one or more mismatching information units included in the first set of information units. Mismatching information units are information items that are not matching to exactly one fully specified and multi-dimensional disease assumption.

Mismatching information units may be used subsequently as entry point for improved and tailored information access by question answering systems. In this way, according to an alternative embodiment, the proposed method may be supported by an iterative user dialogue relying on formalized context categories and related formalized medical background knowledge.

Opposite to known approaches, the proposed embodiment does not neglect but even emphasizes mismatching information units that are sometimes referred to as silent signals by clinicians.

The proposed embodiment follows a rationality of a differential diagnosis. Conducting a differential diagnosis, a clinician may collect an initial set of symptoms and observations arriving at a suspected diagnosis. For subsequent acts in the decision making process, the clinician collects all relevant information units that are of relevance in the context of the particular patient and the suspected diagnosis. Some information units may not be matching to the suspected diagnosis. These silent signals, however, may be a decisive factor for the diagnosis and the further fate of the patient. It is in the professional discretion of the clinician of either disregarding such mismatching information unit or amending the initially suspected diagnosis, sometimes to an extent that the initially suspected diagnosis is replaced by another diagnosis.

The proposed embodiment makes use of the advantages of a differential diagnosis while reducing or even eliminating the need for consulting professional experience of a clinician.

Having identified a mismatching information unit, a further suspected observation is inferred by querying and reasoning the mismatching information unit in at least one knowledge model, whereby the mismatching information unit is related by a still un-typified relationship. At least one further information unit for interrelating the un-typified relationship is requested, either from a knowledge model or by an input of a clinician, in order to consolidate the suspected observation. The un-typified relationship is proven by querying and reasoning the un-typified relationship in at least one knowledge model. Eventually, the typified observation is integrated into the patient knowledge model, whereby a weight assigned to each relationships of the patient knowledge model is updated.

### BRIEF DESCRIPTION OF THE DRAWING

FIG. 1 shows a structural view of functional components of a system according to an embodiment;

FIG. 2 shows a structural view illustrating an operation of a method for supporting a clinical diagnosis according to an embodiment; and

FIG. 3 shows a structural view of executing an identification of mismatching information units according to an embodiment.

### DETAILED DESCRIPTION

The embodiments support a rational of a differential diagnosis. Conducting a known classical differential diagnosis, a clinician may collect an initial set of information units via an anamnesis.

Hereinafter, information units may be all kinds of data characterizing a state of a patient, including but not limited to symptoms, findings, clinical history, medications, observations and influencing factors of a patient.

Apart from the traditional symptom-disease view, influencing factors further include aspects of an external domain (e.g., personal circumstances of a patient).

The relevance of information units is interpreted in the context of some assumption, such as initially suspected diagnosis. In the progress of a known classical differential diagnosis, the clinician aims to exclude suspected diseases (e.g., if other symptoms associated with an initially suspected disease are proven as absent). For doing so, additional examinations helping the clinician to learn more about open or absent symptoms are executed. The selected suspected diagnosis as well as influencing factors determine the context for subsequent interpretation task.

For being able to specify the precise information need in terms of formulating a specific question, a question answering system may be able to answer in the context of an initial formulated suspected diagnosis. The question answering system is to analyze a comprehensive set of data covering all relevant influencing factors of symptoms, findings, and observation in order to identify mismatching information units. Mismatching information units are information items that are not matching to exactly one fully specified and multi-dimensional observation model.

In the context of a clinician, the following questions are of importance during the observation. Are all influencing parameters appropriately assessed? Are all observations, therapies, areas observed for a certain diagnosis? Are all factors and influencing factors, interactions with drugs or historical vita, included? Which observation or feature does not fit the current diagnosis?

In the following, an exemplary case is considered. A patient arrives at an airport from a sports event experiencing the symptoms of headache, tiredness, and leg pain. While the headache and tiredness clearly satisfy the finding of fatigue, the leg pain may need a different observation. In other words, the leg pain may refer to the exhausting sport event, but the leg pain does not necessarily match to the possible finding of fatigue. However, incorporating the context of the recent flight, the clinician may also include the observation of thromboses as a potential finding.

In this context, a clinician is to question and answer the following. Which internal and external constraints are to be asked and incorporated during the observation? This question is directed to a patient context. What is the overall concept of the initial diagnosis (e.g., fatigue)? A possible overall concept of fatigue is, for example, weakness. This question is directed to an assumption context. Which drugs may cause this fatigue? This question is directed to an internal diagnose context. Are there any further diseases that are to be observed (e.g., inflammation)? This question is directed to an external diagnose context. Which symptoms are not identifiable due to the current medications? This question is directed to a procedure context.

The identification of mismatching information is therefore of high importance within clinical diagnose decision. In other words, different to classical question answering systems, where the matching (e.g., best matching) information units (e.g., information units matching to a prior specified representation model) are used, the question answering approach may not be applied in the context of guided question answering for clinical diagnoses. Due to the above illustrated particular information need of clinicians, the classical approach of question answering and information retrieval systems are not appropriate for clinicians in order to access relevant information units.

According to an embodiment, an interactive mechanism supporting effective information access of specific and detailed information units in the context of clinical diagnosis is established.

According to an embodiment, an iterative user dialogue is proposed, relying on formalized context categories as well as related formalized medical background knowledge.

Embodiments disclosed herein aim to support medical experts in the process of specifying and fine-tuning initial search requests by aggregating additional information about the patient context (e.g., patient, assumption, internal diagnose, external diagnose and procedure context). Mismatching information units are subsequently used as entry point for improved and tailored information access using question answering systems.

In general, question answering systems apply an information retrieval approach for candidate retrieval, evidence ranking, and answer prediction. In other words, most question answering systems are using a collection of natural language documents (e.g., local or web-based text corpus) for document retrieval, and apply selective methods in order to rank and extract a single answer or a list of answer candidates.

Known scoring techniques are thereby primarily based on a given matching criteria. An exemplary matching criterion is a degree of syntax or semantic overlap, which is determined by cosine similarity. In other words, the relevance ranking of answers in a search request is calculated by comparing the intersection (e.g., the dot product in vector space) of an answer candidate with the query.

A given question (e.g., request, a query or a patient knowledge mode including information units of symptoms) is converted into a certain query representation potentially extended against a set of data sources. The potential answering information units (e.g., a collection of diseases with associated symptoms) are analyzed and re-ranked based on the best match to the initial hypothesis.

In the context of the exemplary patient stated example, traditional question answering systems may define an input representation for patient X as Patient_X {Symptom(headache), Symptom(tiredness), Symptom(leg pain)}.

Traditional question answering systems would further rank, in the context of generating an answer, a number of N diseases by:

### Disease_{—}1 {Symptom(headache), Symptom(tiredness)}

Disease_{—}2 {Symptom(headache), Symptom(sleep disorders)}

[symbol]

Disease_N {Symptom(blood clot), Symptom(leg pain), Symptom(leg fatigue)}

As a result of the traditional similarity-driven evidence ranking, >>Migraine<<, which is captioned above as Disease_{—}1, and >>Tension Headache<<, which is captioned above as Disease_{—}2, rather than >>Thrombosis<<, which is captioned above as Disease_N, may be ranked within the top of suggested findings, since the constraint satisfaction of symptom-based overlap proposes this solution. In other words, these traditional approaches are primarily considering best matching answer candidates, though disregarding symptoms (e.g., leg pain). This consideration may result in a different diagnosis.

Different to this traditional similarity-driven evidence ranking, the proposed embodiments establish an approach that does not disregard the mismatching information.

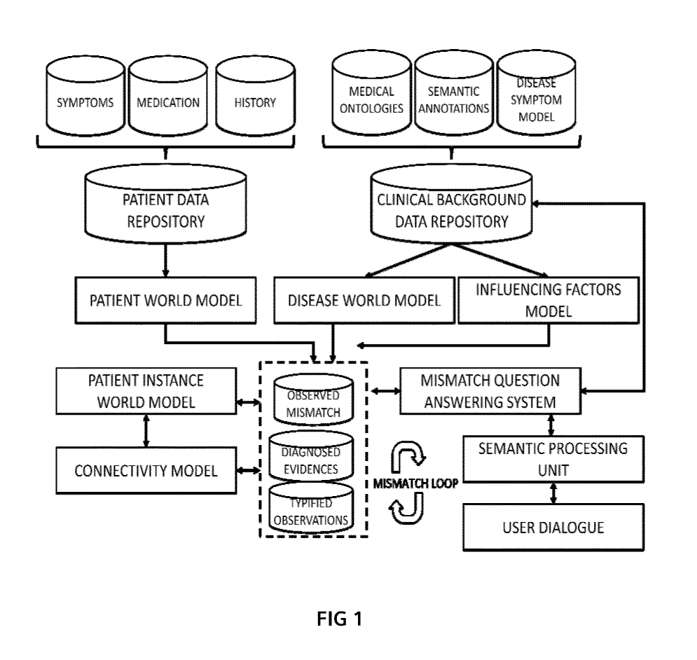

FIG. 1 shows functional components of a system according to an embodiment.

By a Clinical Background Data Repository, an influencing factor knowledge model, a disease world model and possibly other medical ontologies, semantic annotations and symptom models are stored or accessed.

By a Patient Data Repository, any type of symptoms, findings, measurement, sign, or clinical observations with regards to a given patient and associated patient records are stored or accessed.

A Patient World Model (e.g., a Patient Knowledge Model) includes information units regarding symptoms of a specifically observed patient (e.g., symptoms, medical history, medications, private events, context, etc.), with past or current relevancy for the heath state of the patient, and thus, influencing the behavior of past and current treatments or medications. Thus, the patient knowledge model encompasses any historical and longitudinal health data of the patients enhanced by semantic inference and conclusions. This knowledge model is formalized in a sense that the information units may be fixed (e.g., will not be changed in the course of a user interaction process).

A Disease World Model (e.g., a disease knowledge model) is a formalized knowledge model capturing relevant information units (e.g., symptoms, history, medications, age, etc.) influencing a given disease. This knowledge model is formalized in a sense that the information units may be fixed (e.g., will not be changed in the course of a user interaction process). The disease knowledge model covers comprehensive information about possible relationships between diseases and symptoms. Each disease relates to a plurality of leading symptoms and a set of possible symptoms, or medication relationship. Information units in the disease knowledge model are captured from traditional medical textbooks and structured repositories.

An Influencing Factors Model includes information units of a specifically observed patient covering comprehensive information units to be considered during an observation phase (e.g., symptoms, history, and medications). Apart from traditional factors (e.g., internal factors; symptoms of a disease), the information units additionally account aspects of an external domain (e.g., a recent flight or a thrombosis risk of the patient). In one embodiment, these influencing factors are organized by a taxonomy.

In order to amend the patient knowledge model by updating a weight assigned to relationships between information units in the process of specifying, fine-tuning or even altering an initial disease assumption, instantiated knowledge of the static Patient Knowledge Model is provided according to an embodiment. This instantiated knowledge model of the static Patient Knowledge Model is captioned Patient Instance World Model. The instantiated knowledge model is an outcome of the entire interactive process. Eventually, the instantiated knowledge model includes validated and weighted relationships of validated information units capturing all weak and strong relationship between the Patient World Model and the Disease World Model, by taking the Taxonomy of Influencing Factors and all typified observations into account.

A Connectivity Model includes representations of relationships in a graph-based representation. A graph of weighted edges (e.g., relationships), which are typified and enriched during the examination phase, forms the basis for modeling diagnoses and findings for a given instance of a patient and associated typified observation. A relationship is also referred to as signal or edge in terminology of the graph-based connectivity model.

A Mismatch Question Answering System is supporting an interactive process of converting suspected observations using a set of influencing factors into typified observations.

A given suspected observation is proofed on validity in the patient knowledge model and in the disease knowledge model. The knowledge model of influencing factors determines which information units are missing in order to establish a comprehensive background context data set as modeled with the connectivity model and instantiated within the Patient Instance World Model.

Using an optional interactive User Dialogue that requests missing information units from the clinician, a connection of the knowledge model of influencing factors is enabled in order to complete a background context data set in the Patient Instance World Model. The interactive User Dialogue enforces a feedback mechanism for mismatching information units and for proposed examinations.

A Semantic Processing Unit invoked by the Mismatch Question Answering System compares normal or expected data with the Clinical Background Data Repository, typifies observations using validated constraints (e.g., influencing factors), and assesses the weight of relationships (i.e., the signal strength of observations).

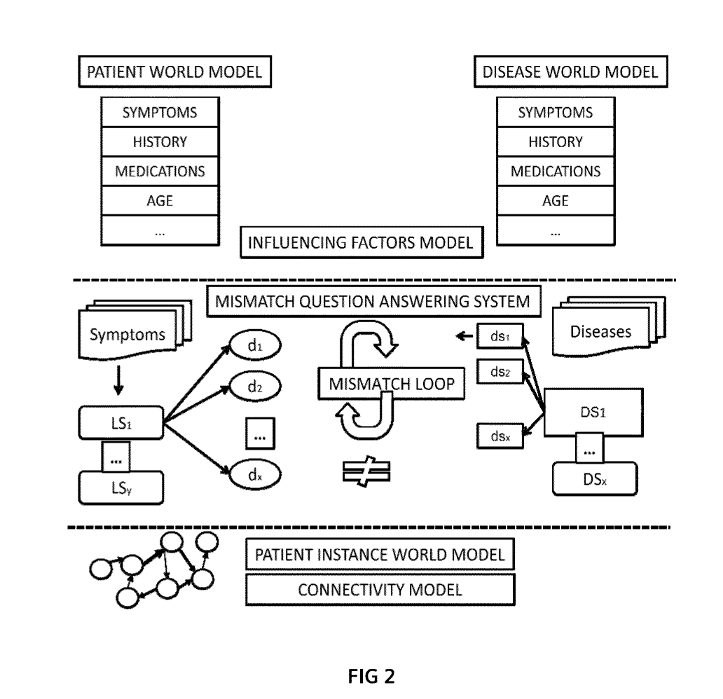

FIG. 2 shows an operation of a method for supporting a clinical diagnosis according to an embodiment.

FIG. 2 again shows the Disease World Model (e.g., a disease knowledge model) as a formalized knowledge model capturing relevant information units (e.g., symptoms, history, medications, age, etc.) influencing a given disease. The Patient World Model (e.g., a Patient Knowledge Model) includes information units regarding symptoms of a specifically observed patient, symptoms, history, medications, age, etc., with past or current relevancy for the heath state of the patient and thus influencing the behavior of past and current treatments or medications.

A structure of a connectivity model is depicted in the bottom left of FIG. 2. The connectivity model includes observations that are represented by a circle and relationships that are represented by an arrow. At least two information units interrelated by a relationship are referred to as observation.

In the center of FIG. 2, between two dotted vertical lines, an operation of the Mismatch Question Answering System is shown.

In a first act, a first set of symptoms LS1, . . . LSy, or information units LS1, . . . LSy in general, within the patient knowledge model is determined.

In a subsequent act, a plurality of disease assumptions d1, d2, . . . dx are determined by querying and reasoning the first set of information units LS1, . . . LSy in the disease knowledge model. A disease assumption d1 is selected and retrieved in the disease knowledge model as disease assumption DS1.

A second set of information units ds1, ds2, . . . dsx is determined associated by the disease knowledge model with the disease assumption DS1.

In another act, the second set of information units ds1, ds2, . . . dsx is matched to the first set of information units LS1, . . . LSy.

In another act, at least one mismatching information unit is identified as included in the first set of information units.

Within the patient knowledge model or Patient World Model, each patient is represented by a plurality of information units including any type of symptoms, findings, measurement, sign, or clinical observations, etc. These factors are discovered (e.g., during the initial anamnesis examinations and the given historical patient record). The information units are optionally already classified by categories of influencing factors.

According to an embodiment, an instance of the patient knowledge model is built. Information units and observed influencing factors are modeled within a Patient Instance World Model. In an initial stage, after instantiation, the Patient Instance World Model is only partial complete and represents one instance subset of the Patient World Model. However, some information units may be already classified by categories of influencing factors. In a further stage, initial influencing factors and other information units are consolidated as typified observations.

The patient knowledge model or a corresponding instantiated Patient Instance World Model further includes at least one observation, whereby an observation includes at least one information unit that is interrelated with at least one further information unit by at least one relationship.

Based on the already present partial information and the given set of disease assumptions drawn from the Disease World Model, an optional user dialog is applied in order to complete assumed diseases of the Patient Instance World Model using the knowledge model of influencing factors and the Disease World Model. In other words, any missing observations within the initial disease observation gets executed and poses as a candidate to be added to the Patient Instance World Model as un-typified relationship within the Connectivity Model.

Each new acquired incoming information unit candidate, characterized by un-typified relationship within the Connectivity Model, gets compared with expected data sets (e.g., normal values) in order to validate and rate already matching information units. In addition, for each observed disease, the mismatching information units are identified.

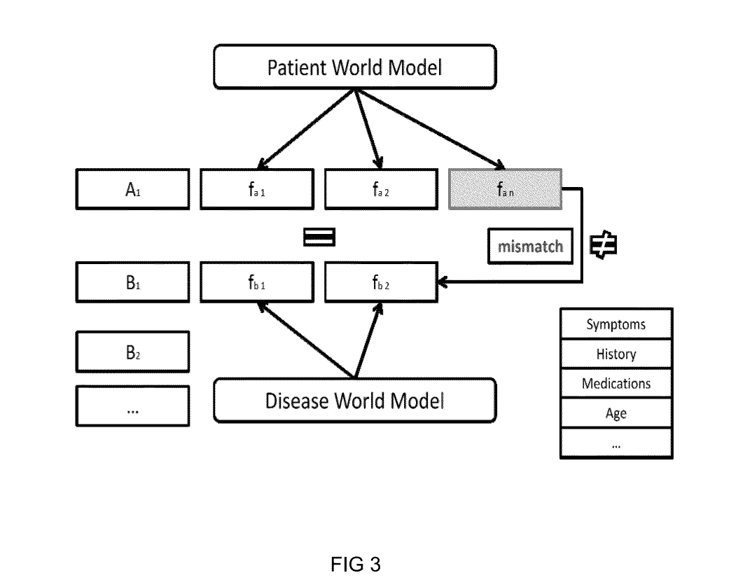

FIG. 3 details one embodiment of the mismatching process. FIG. 3 shows a structural view of executing an identification of mismatching information units comparing the Patient World Model with the Disease World Model.

In other words, a first set A1 of information units fa1, fa2, . . . , fan that are exemplarily assigned to the following information units is provided:

fa1=Symptom(headache)
fa2=Symptom(tiredness)
fa3=Symptom(leg pain)

This first set of information units fa1, fa2, . . . , fan which is taken from an exemplary patient knowledge model or Patient World Model, is to be matched with a second set B1 of information units fb1, fb2. A list of diseases B1, B2, . . . Bx is derived from the disease knowledge model or Disease World Model. The second set B1 is related to a disease assumption associated with information units fb1, fb2.

Each disease assumption (e.g., disease assumption B1) is compared by symptoms, influencing factors and/or information units fb1, fb2 of the disease assumption. The mismatching information unit fan included in the first set of information units is identified by detecting the information unit fan within the Patient World Model that is not represented in the respective Disease World Model.

By querying and reasoning the mismatching information unit in the disease knowledge model or in the knowledge model of influencing factors, at least one suspected observation including the mismatching information unit is inferred, whereby the mismatching information unit is related by at least one un-typified relationship. Any suspected observation within the initial disease observation gets executed and poses as a candidate to be added to the Patient Instance World Model as un-typified relationships within the Connectivity Model.

Based on the set of mismatching information units for a given observed disease, suspected observations are consolidated into typified observations by requesting at least one further information unit for interrelating the un-typified relationship. Each acquired information unit candidate, having an un-typified relationship within the Connectivity Model, gets compared with the expected data sets (e.g., normal values) in order to validate and rate already matching information units.

Optionally, a further information unit is requested from an input by a clinician. Based on the partial information that is present and the given set of disease assumptions drawn from the Disease World Model, an optional user dialog for requesting an input by a clinician is used in order to complete the Patient Instance World Model for each assumed disease using the knowledge model of influencing factors and the Disease World Model.

The suspected observations are consolidated into typified observations by requesting at least one further information unit for interrelating the un-typified relationship.

A further information unit is requested from a knowledge model or from an input by a clinician. Additionally required observations are optionally proposed in order to typify the set of possible influencing factors. Related influencing factors are extracted by the knowledge model of influencing factors and the disease knowledge model, or Disease World Model. The Disease World Model is based on a Semantic Processing Unit that compares the normal or expected data with the collected data references.

In a further act, one or each of the un-typified relationship is proofed by querying and reasoning the un-typified relationship by the patient knowledge model and/or a further knowledge model. The Connectivity Model is updated based on the newly added information units. Un-typified relationships proven by this act are referred to as typified relationship.

In a further act, the at least one typified observation is integrated into the patient knowledge model while updating a weight assigned to the relationships. Updating the weight of relationships may lead to a stronger consideration of mismatching information, serving the purpose of reassessing a diagnosis in view of, for example, silent signals. The weight assigned to relationships is also referred to as signal strength. Optionally, all typified observations are ranked by their signal strength.

All typified observations defined by the Mismatch Question Answering System are added to the Patient Instance World Model. The set of typified observations are compared to weak signals that carry the most relevant information required for a clinical decision making process. An optional User Interaction Dialogue module is activated if the system decides that additional information is to be asked by the clinician.

The interactive system optionally iterates until all relationships are typified within the Connectivity Model, and/or no additional information units are acquired. The clinician is able to interrupt at any act of the interactive mechanism.

Embodiments may be implemented in computing hardware (e.g., computing apparatus; one or more processors) and/or software, including but not limited to any computer that may store, retrieve, process and/or output data and/or communicate with other computers.

The processes can also be distributed via, for example, downloading over a network such as the Internet. The results produced may be output to a display device, printer, readily accessible memory or another computer on a network. A program/software implementing the embodiments may be recorded on computer-readable media including non-transitory computer-readable recording media. The program/software implementing the embodiments may also be transmitted over a transmission communication media such as a carrier wave.

Reference to embodiments and examples are provided. Variations and modifications may be effected within the spirit and scope of the invention covered by the claims.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for supporting a clinical diagnosis, the method comprising:
representing a patient by a patient knowledge model including a plurality of information units and further including at least one observation, the at least one observation including at least one information unit interrelated with at least one further information unit by at least one relationship;
determining a first set of information units within the patient knowledge model;
determining a disease assumption, the determining of the disease assumption comprising querying and reasoning the first set of information units in a disease knowledge model;
determining a second set of information units associated by the disease knowledge model with the disease assumption and matching the second set of information units to the first set of information units;
identifying at least one mismatching information unit included in the first set of information units;
inferring, by querying and reasoning the mismatching information unit in at least one of the disease knowledge model or one of a further knowledge model, at least one suspected observation including the mismatching information unit, the mismatching information unit related by at least one un-typified relationship;
consolidating the at least one suspected observation into at least one typified observation, the consolidating comprising requesting at least one further information unit for interrelating the at least one un-typified relationship;
proofing the at least one un-typified relationship, the proofing comprising querying and reasoning the at least one un-typified relationship in at least one of the patient knowledge model or one of a further knowledge model; and
integrating the at least one typified observation into the patient knowledge model and updating a weight assigned to the relationships.

2. The method of claim 1, further comprising requesting further information units by a user-dialogue.

3. The method of claim 1, wherein the patient knowledge model is instantiated.

4. The method of claim 1, wherein the plurality of information units includes symptoms, findings, clinical history, medications, observations and influencing factors related to the patient.

5. The method of claim 1, further comprising recurring the determining of the first set of information units, the determining of the disease assumption, the determining of the second set of information units, the identifying, the inferring, the consolidating, the proofing, and the integrating until all relationships are typified or until no further information units are requested by the consolidating.

6. The method of claim 1, further comprising ranking typified observations by a signal strength of the typified observations.

7. A question answering system for supporting a clinical diagnosis, the system comprising:
a processor configured to:
represent a patient by a patient knowledge model including a plurality of information units and further including at least one observation, the at least one observation including at least one information unit interrelated with at least one further information unit by at least one relationship;
determine a first set of information units within the patient knowledge model;
determine a disease assumption, the determination of the disease assumption comprising querying and reasoning the first set of information units in a disease knowledge model;
determine a second set of information units associated by the disease knowledge model with the disease assumption and match the second set of information units to the first set of information units;
identify at least one mismatching information unit included in the first set of information units;
infer, by querying and reasoning the mismatching information unit in at least one of the disease knowledge model or one of a further knowledge model, at least one suspected observation including the mismatching information unit, the mismatching information unit related by at least one un-typified relationship;
consolidate the at least one suspected observation into at least one typified observation, the consolidation comprising requesting at least one further information unit for interrelating the at least one un-typified relationship;
proof the at least one un-typified relationship, the proof comprising querying and reasoning the at least one un-typified relationship in at least one of the patient knowledge model or one of a further knowledge model; and
integrate the at least one typified observation into the patient knowledge model and update a weight assigned to the relationships.

8. The question answering system of claim 7, wherein the processor is further configured to request further information units by a user-dialogue.

9. The question answering system of claim 7, wherein the patient knowledge model is instantiated.

10. The question answering system of claim 7, wherein the plurality of information units includes symptoms, findings, clinical history, medications, observations and influencing factors related to the patient.

11. The question answering system of claim 7, wherein the processor is further configured to recur the determination of the first set of information units, the determination of the disease assumption, the determination of the second set of information units, the identification, the inference, the consolidation, the proof, and the integration until all relationships are typified or until no further information units are requested by the consolidation.

12. The question answering system of claim 7, wherein the processor is further configured to rank typified observations by a signal strength of the typified observations.

13. A computer program product comprising program code stored on a non-transitory computer-readable storage medium, the program code, when executed on a computer, is configured to:
represent a patient by a patient knowledge model including a plurality of information units and further including at least one observation, the at least one observation including at least one information unit interrelated with at least one further information unit by at least one relationship;
determine a first set of information units of the plurality of information units within the patient knowledge model;
determine a disease assumption, the determination of the disease assumption comprising querying and reasoning the first set of information units in a disease knowledge model;
determine a second set of information units of the plurality of information units associated by the disease knowledge model with the disease assumption and match the second set of information units to the first set of information units;
identify at least one mismatching information unit included in the first set of information units;
infer, by querying and reasoning the mismatching information unit in at least one of the disease knowledge model or one of a further knowledge model, at least one suspected observation including the mismatching information unit, the mismatching information unit related by at least one un-typified relationship;
consolidate the at least one suspected observation into at least one typified observation, the consolidation comprising requesting at least one further information unit for interrelating the un-typified relationship;
proof said at least one un-typified relationship, the proof comprising querying and reasoning the at least one un-typified relationship in at least one of the patient knowledge model or one of a further knowledge model; and
integrate the at least one typified observation into the patient knowledge model and update a weight assigned to the relationships.

14. The computer program product of claim 13, wherein the program code is further configured to request further information units by a user-dialogue.

15. The computer program product of claim 13, wherein the patient knowledge model is instantiated.

16. The computer program product of claim 13, wherein the plurality of information units includes symptoms, findings, clinical history, medications, observations and influencing factors related to the patient.

17. The computer program product of claim 13, wherein the program code is further configured to recur the determination of the first set of information units, the determination of the disease assumption, the determination of the second set of information units, the identification, the inference, the consolidation, the proof, and the integration until all relationships are typified or until no further information units are requested by the consolidation.

18. The computer program product of claim 13, wherein the program code is further configured to rank typified observations by a signal strength of the typified observations.
